(19) United States
(12) Patent Application Publication
(10) Pub. No.: US 2014/0149499 A1
(43) Pub. Date: May 29, 2014

(54) REMOTE REQUEST FULFILLMENT AND DELIVERY

(71) Applicant: APPSENSE LIMITED, Warrington (GB)

(72) Inventors: Richard POINTON, Church Lawton (GB); Richard James SOMERFIELD, Cheshire (GB); James TUPPER, Warrington (GB)

(73) Assignee: APPSENSE LIMITED, Warrington (GB)

(21) Appl. No.: 13/685,389

(22) Filed: Nov. 26, 2012

(51) Int. Cl. H04L 29/08

(52) U.S. Cl. CPC H04L 67/00
USPC 709/204

(57) ABSTRACT

Systems and methods are described for described for providing remote request fulfillment and delivery. A computerized method of sharing and distributing data among computing devices includes receiving at a server a request from a first computing device, wherein the request targets a second computing device and contains information about a data object, retrieving, using the server, at least a portion of the data object from a source of the data object, determining, using the server, attributes of the second computing device, adapting at least a portion of the data object according to the attributes of the second computing device, and notifying the second computing device of an availability of the data object.

### BACKGROUND

Sharing and distributing data among remote devices can be challenging, especially when the remote devices have limited resources or availabilities (e.g., mobile devices with unstable or slow connections). Downloading large amount of data may be difficult due to environmental factors such as network bandwidth, availability, and reliability. Remote devices with limited resources may not be able to handle the heavy-lifting of distributing and sharing large amounts of data. Additional problems can also arise during file sharing when the capabilities, configuration, availability, or status of remote devices are unknown. In addition, stronger control, better flexibility, and higher efficiency are desired in file sharing and distribution among remote devices.

### SUMMARY

In accordance with the disclosed subject matter, systems and methods are described for providing remote request fulfillment and delivery.

Disclosed subject matter includes, in one aspect, a computerized method of sharing and distributing data among computing devices, which includes receiving at a server a request from a first computing device, wherein the request targets a second computing device and contains information about a data object, retrieving, using the server, at least a portion of the data object from a source of the data object, determining, using the server, attributes of the second computing device, adapting at least a portion of the data object according to the attributes of the second computing device, and notifying the second computing device of an availability of the data object.

In some embodiments, the source of the data object is related to a third computing device.

In some embodiments, the determining step includes determining configuration of the second computing device.

In some embodiments, the adapting step includes converting the at least a portion of the data object into a different format suitable for the second computing device.

In some embodiments, the retrieving step includes retrieving the at least a portion of the data object based on a schedule.

In some embodiments, the retrieving step includes retrieving the at least a portion of the data object on a recurring basis.

In some embodiments, the computerized method further includes retrieving more of the data object based on a response from the second computing device.

Disclosed subject matter includes, in another aspect, a non-transitory computer readable medium having executable instructions operable to, when executed by a processor, cause the processor to receive at a server a request from a first computing device, wherein the request targets at a second computing device and contains information about a data object, retrieve, using the server, at least a portion of the data object from a source of the data object, determine, using the server, attributes of the second computing device, adapt at least a portion of the data object according to the attributes of the second computing device, and notify the second computing device of an availability of the data object.

In some embodiments, the source of the data object is related to a third computing device.

In some embodiments, the executable instructions are further operable to cause the processor to determine configuration of the second computing device.

In some embodiments, the executable instructions are further operable to cause the processor to convert the at least a portion of the data object into a different format suitable for the second computing device.

In some embodiments, the executable instructions are further operable to cause the processor to retrieve the at least a portion of the data object based on a schedule.

In some embodiments, the executable instructions are further operable to cause the processor to retrieve the at least a portion of the data object on a recurring basis.

In some embodiments, the executable instructions are further operable to cause the processor to retrieve more of the data object based on a response from the second computing device.

Disclosed subject matter includes, in another aspect, a control server for managing sharing and distributing data among computing devices, which includes a non-transitory memory storing computer readable instructions, a client directory, and a file directory, and a processor coupled to the non-transitory memory and configured to execute the computer readable instructions, wherein the computer readable instructions are configured to cause the control server to: receive at the control server a request from a first client, wherein the request targets a second client and contains information about a data object, retrieve, using the control server, at least a portion of the data object from a source of the data object, determine, using the control server, attributes of the second client, adapt at least a portion of the data object according to the attributes of the second client, and notify the second client of an availability of the data object.

In some embodiments, the source of the data object is related to a third computing device.

In some embodiments, the computer readable instructions are further configured to cause the control server to determine configuration of the second client.

In some embodiments, the computer readable instructions are further configured to cause the control server to convert the at least a portion of the data object into a different format suitable for the second client.

In some embodiments, the computer readable instructions are further configured to cause the control server to retrieve the at least a portion of the data object based on a schedule.

In some embodiments, the computer readable instructions are further configured to cause the control server to retrieve the at least a portion of the data object on a recurring basis.

In some embodiments, the computer readable instructions are further configured to cause the control server to retrieve more of the data object based on a response from the second client.

Various embodiments of the subject matter disclosed herein can provide one or more of the following capabilities. A remote request fulfillment and delivery system can present more efficient and flexible mechanisms of distributing and sharing data among remote devices. A remote request fulfillment and delivery system can help off-load the resource-intensive aspects of sharing and distributing to a server that usually has more bandwidth and computing resources to handle such tasks. A remote request fulfillment and delivery system can also relieve user frustration when data cannot be shared or distributed due to its size or availability, thus improving user experiences in sharing and distributing data in a networked environment (e.g., the Internet).

These and other capabilities of embodiments of the invention will be more fully understood after a review of the following figures, detailed description, and claims.

### BRIEF DESCRIPTION OF THE DRAWINGS

FIG. 1 illustrates a diagram of an exemplary networked communication system.

FIG. 2 illustrates a block diagram of an exemplary remote request fulfillment and delivery system.

FIG. 3 illustrates a block diagram of an exemplary fulfillment and delivery agent in a remote request fulfillment and delivery system.

FIG. 4 illustrates an exemplary fulfillment and delivery client (FDC) directory in a remote request fulfillment and delivery system.

FIG. 5 illustrates an exemplary fulfillment and delivery file (FDF) directory in a remote request fulfillment and delivery system.

FIG. 6 illustrates an exemplary operation of a remote request fulfillment and delivery system.

FIG. 7 illustrates a block diagram of an exemplary fulfillment and delivery client in a remote request fulfillment and delivery system.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the embodiments described below are only examples, and that it is contemplated that there are other systems and methods that are within the scope of the disclosed subject matter.

One exemplary user scenario of sharing and distributing data among multiple devices according to embodiments of the disclosed subject matter is following: User A working with Device A wants to sharing a large video file with User B working with Device B. User A has no or little information about User B or Devices B (e.g., its capabilities, online status, any limitations or preferences, etc.). The large video file is stored on a third-party storage resource. Instead of sending the large video file to Device B directly, Device A sends a request to a control server. The control server in turn retrieves the large video file from the third-party storage resource. Unlike User A or Device A, the control server has knowledge about User B and/or Device B (e.g., its capabilities, online status, limitations, or preferences, etc.). When the control server determines that the downloaded large video is in a format incompatible with Device B, the control server transforms the file into another form which is playable on Device B. After the transformation, the control server notifies Device B that User A or Device A wants to share a video file. Once Device B responds positively, the control server can send the compatible video file to Device B according to Device B's preference.

Embodiments of the disclosed subject matter can provide techniques for sharing and distributing data among remote devices. A remote request fulfillment and delivery system can present more efficient and flexible mechanisms of distributing and sharing files among remote devices. An exemplary remote request fulfillment and delivery system can include at least one fulfillment and delivery server and multiple fulfillment and delivery clients. A fulfillment and delivery server can help manage and control the operations of the remote request fulfillment and delivery system. An exemplary operation is now described. First and second fulfillment and delivery clients register with a fulfillment and delivery server. The first fulfillment and delivery client initiates a remote request to distribute a file to the second fulfillment and delivery client. The remote request contains minimum information identifying the file to be distributed. The file itself can reside on a third-party remote data source. The fulfillment and delivery server can receive and process the remote request, e.g., the fulfillment and delivery server downloads the file from the remote data source and can transform the downloaded file into a form which is suitable for the second fulfillment and delivery client. The transformation can be based on, for example, the capabilities, configuration, and policies of the second fulfillment and delivery client. The fulfillment and delivery server can then notify the second fulfillment and delivery client of the remote request.

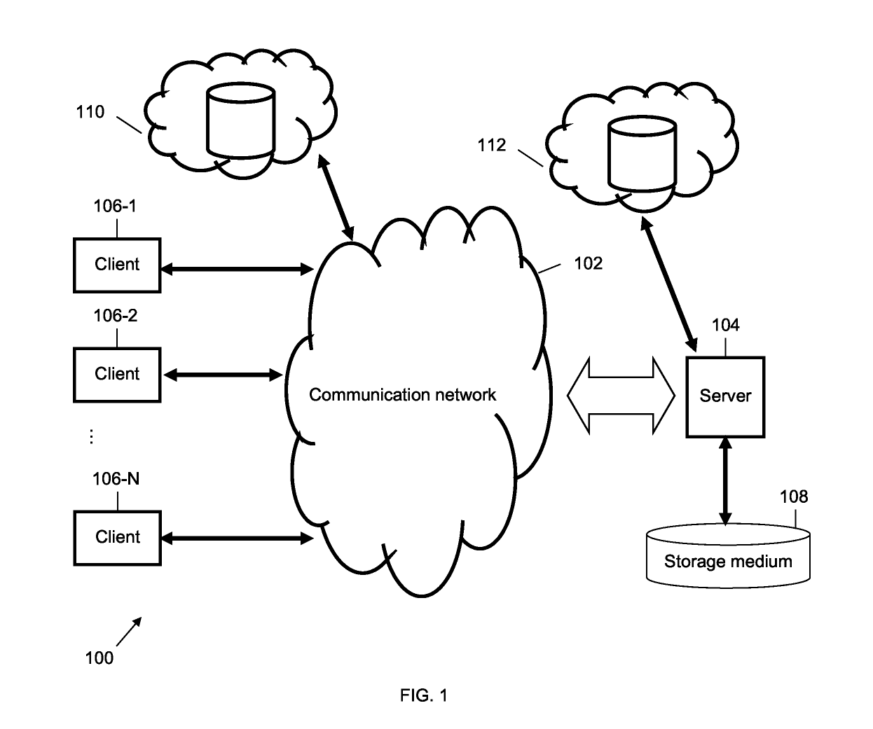

Embodiments of the disclosed subject matter can be implemented in a networked computing system. FIG. 1 illustrates a diagram of an exemplary networked communication arrangement 100 in accordance with an embodiment of the disclosed subject matter. The networked communication arrangement 100 can include a server 104, at least one client 106 (e.g., client 106-1, 106-2, . . . 106-N), a physical storage medium 108, and a cloud storage 110 and 112, which can all be coupled, directly or indirectly to a communication network 102.

Each client 106 can communicate with the server 104 to send data to, and receive data from, the server 104 across the communication network 102. Each client 106 can be directly coupled to the server 104; alternatively, each client 106 can be connected to server 104 via any other suitable device, communication network, or combination thereof. For example, each client 106 can be coupled to the server 104 via one or more routers, switches, access points, and/or communication network (as described below in connection with communication network 102). A client 106 can include, for example, a desktop computer, a mobile computer, a tablet computer, a cellular device, a smartphone, or any computing systems that are capable of performing computation.

Server 104 can be coupled to at least one physical storage medium 108, which can be configured to store data for the server 104. Preferably, any client 106 can store data in, and access data from, the physical storage medium 108 via the server 104. FIG. 1 shows the server 104 and the physical storage medium 108 as separate components; however, the server 104 and physical storage medium 108 can be combined together. FIG. 1 also shows the server 104 as a single server; however, server 104 can include more than one server. FIG. 1 shows the physical storage medium 108 as a single physical storage medium; however, physical storage medium 108 can include more than one physical storage medium. The physical storage medium 108 can be located in the same physical location as the server 104, at a remote location, or any other suitable location or combination of locations.

FIG. 1 shows two embodiments of a cloud storage 110 and 112. Cloud storage 110 and/or 112 can store data from physical storage medium 108 with the same restrictions, security measures, authentication measures, policies, and other features associated with the physical storage medium 108. FIG. 1 shows the cloud storage 112 separate from the communication network 102; however, cloud storage 112 can be part of communication network 102 or another communication network. The server 104 can use only cloud storage 110, only cloud storage 112, or both cloud storages 110 and 112. While, FIG. 1 shows one cloud storage 110 and one cloud storage 112, more than one cloud storage 110 and/or more than one cloud storage 112 or any suitable combination thereof can be used.

The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 1 shows the network 102 as a single network; however, the network 102 can include multiple interconnected networks listed above.

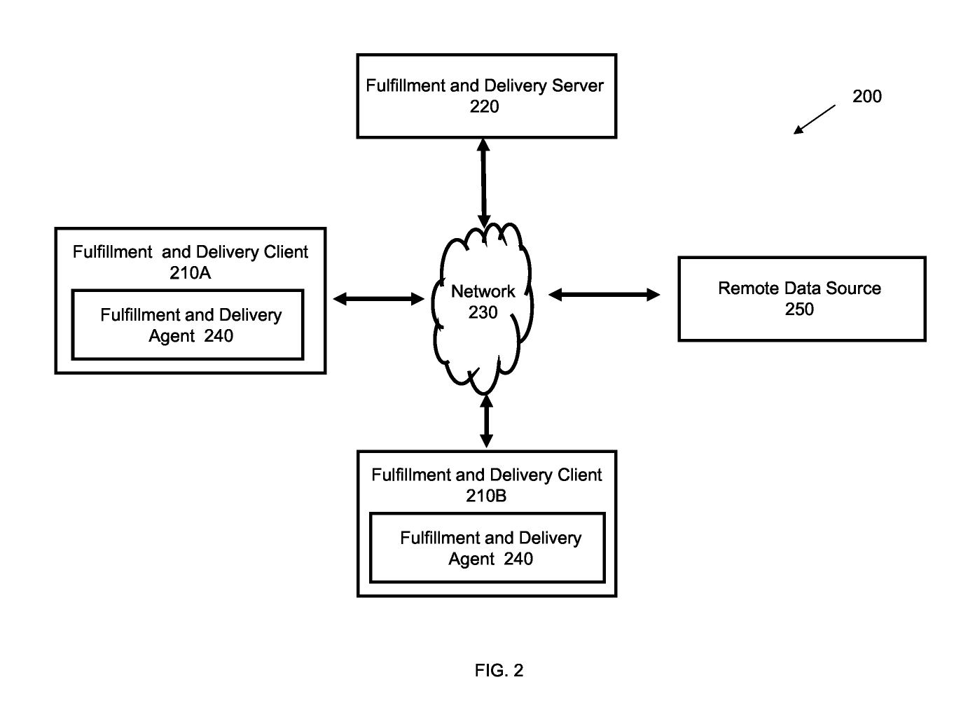

FIG. 2 illustrates a block diagram of a remote request fulfillment and delivery system 200 in accordance with certain embodiments of the disclosed subject matter. The remote request fulfillment and delivery system 200 can include one or more fulfillment and delivery clients 210A and 210B, a fulfillment and delivery server 220, and a network 230. The remote request fulfillment and delivery system 200 can further include a remote data source 250. The fulfillment and delivery clients 210A and 210B, the fulfillment and delivery server 220, and the remote data source 250 can be directly or indirectly coupled to the network 230 and communicate among each other via the network 230, which can be wired, wireless, or a combination of both.

The fulfillment and delivery client 210A or 210B, like each client 106 illustrated in FIG. 1, can include a desktop computer, a mobile computer, a tablet computer, a cellular device, a smartphone, or any computing systems that are capable of performing computation. The fulfillment and delivery server 220 can also include a desktop computer, a mobile computer, a tablet computer, a cellular device, a smartphone, or any computing systems that are capable of performing computation. The remote data source 250 can be operated, controlled, or associated with the same entity that operates, controls, or is associated with the fulfillment and delivery server 220; alternatively, the remote data source 250 can be operated, controlled, or associated with a third party. Although FIG. 2 shows the fulfillment and delivery server 220 as a single server, the fulfillment and delivery server 220 can include more than one physical and/or logical servers. The network 230, like the communication network 102 illustrated in FIG. 1, can include the Internet, a cellular network, a telephone network, a computer network, a packet switching network, a line switching network, a local area network (LAN), a wide area network (WAN), a global area network, a corporate network, an intranet, a virtual network, or any number of private networks currently referred to as an Intranet, and/or any other network or combination of networks that can accommodate data communication. Such networks can be implemented with any number of hardware and software components, transmission media and network protocols. FIG. 2 shows the network 230 as a single network; however, the network 230 can include multiple interconnected networks listed above.

Each fulfillment and delivery client 210A or 210B can include a fulfillment and delivery agent 240. The fulfillment and delivery agent 240 can be embedded inside the fulfillment and delivery client 210A or 210B as a software module, a hardware component, or a combination of both. Alternatively, the fulfillment and delivery agent 240 can also be separate from but coupled to the fulfillment and delivery client 210A or 210B. The fulfillment and delivery client device 210A or 210B can communicate with the fulfillment and delivery server 220 directly or via its agent 240.

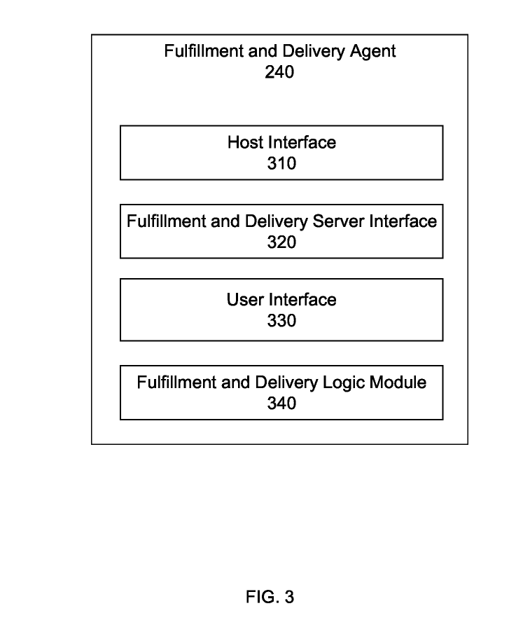

FIG. 3 illustrates a block diagram of an exemplary fulfillment and delivery agent 240 in a remote request fulfillment and delivery system. A fulfillment and delivery agent 240 can include a host interface 310, a fulfillment and delivery server interface 320, a user interface 330, and a fulfillment and delivery logic module 340. The fulfillment and delivery agent 240 can communicate with its associated host (e.g., a fulfillment and delivery client 210A or 210B) through the host interface 310. The fulfillment and delivery agent 240 can communicate with the fulfillment and delivery server 220 through the fulfillment and delivery server interface 320. The fulfillment and delivery agent 240 can also interact with the users through the user interface 330. The fulfillment and delivery logic module 340 can provide application logic and execution of remote request fulfillment and delivery on the fulfillment and delivery client 210A or 210B. In one example, the fulfillment and delivery logic module 340 can retrieve the host client's capabilities (e.g., CPU, memory, network bandwidth, etc.). In another example, the fulfillment and delivery logic module 340 can access and/or customize the configuration (e.g., local applications, restrictions, etc.) of the host client 210A/210B. In yet another example, the fulfillment and delivery logic module 340 can access and/or customize the remote request policies (e.g., time, size, duration, security restriction, etc.) of the host client 210A/210B and/or the fulfillment and delivery system 200. In yet another example, the fulfillment and delivery logic module 340 can get and/or set the group affiliation information of the host client 210A/210B and/or the fulfillment and delivery system 200.

A remote request fulfillment and delivery system 200 can be managed by a fulfillment and delivery server 220. A fulfillment and delivery server 220 can store and maintain a fulfillment and delivery client (FDC) directory and a fulfillment and delivery file (FDF) directory. A FDC directory can keep track of the client devices within the remote request fulfillment and delivery system 200 and their attributes. A FDF directory can keep track of the files being shared and distributed within the remote request fulfillment and delivery system 200 and information about these files. Both directories can help the fulfillment and delivery server 220 manage the remote request fulfillment and delivery system 200.

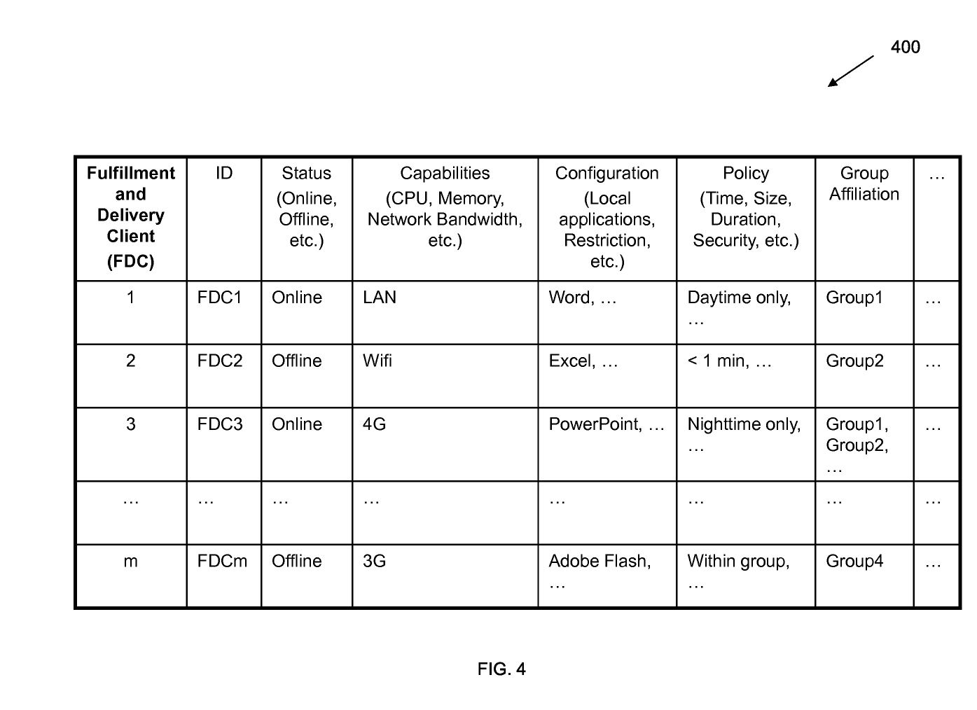

FIG. 4 illustrates an exemplary fulfillment and delivery client (FDC) directory 400 in a remote request fulfillment and delivery system 200. The FDC directory 400 can be used for maintaining information about the client devices within the remote request fulfillment and delivery system 200. The FDC directory 400 can contain the relevant information about each of the fulfillment and delivery clients (e.g., client 1-m) in the fulfillment and delivery system 200. The FDC directory 400 can be updated manually or automatically when a fulfillment and delivery client is added/removed/modified. For each fulfillment and delivery client (e.g., client 1-m), the FDC directory 400 can include information, such as client ID, status, capabilities, configuration, policy, and group affiliation, etc.

The client ID (e.g., FDC1-m) of a fulfillment and delivery client can be used to uniquely identify a fulfillment and delivery client. The client ID can be assigned by the fulfillment and delivery client or its user. The client ID can also be a randomly generated globally unique identifier (GUID) that uniquely identifies a client in the remote request fulfillment and delivery system 200. In some embodiments, the client ID can be derived from existing information to identify a fulfillment and delivery client. For example, the client ID can be in the form of or derived from the Media Access Control (MAC) address of a network interface of the fulfillment and delivery client. Other forms of globally unique identifiers can also be used in the fulfillment and delivery directory.

The status column in the FDC directory 400 can contain information about the current status of each fulfillment and delivery client. For example, the status can indicate whether a fulfillment and delivery client is online or offline. A fulfillment and delivery client can automatically send its online status to the fulfillment and delivery server when its online status changes. In some embodiments, a fulfillment and delivery server can treat a fulfillment and delivery client as offline if no update has been received from the fulfillment and delivery client for a certain period of time. Alternatively, a fulfillment and delivery client or its user can set its online status manually. For example, a user who prefers not to receive a remote request can choose to manually set its fulfillment and delivery client to offline. Other types of client status information can also be included in the fulfillment and delivery directory.

The capabilities column in the FDC directory 400 can contain information about the system capabilities of each fulfillment and delivery client. The capabilities information can include, for example, the CPU specification, the memory capacity and speed, the network connection type and bandwidth, etc. For example, the network connection type information can indicate if the fulfillment and delivery client has a LAN connection, a WIFI connection, and/or a cellular connection (e.g., 4G/LTE), etc. The network bandwidth information can indicate the minimum, average, or peak bandwidth, etc. For example, the capabilities information can indicate that a fulfillment and delivery client has an Intel dual-core processor with 4 GB memory and a WIFI connection with a peak bandwidth of 100 Mbps. Other types of client capabilities information can also be included in the fulfillment and delivery directory.

The configuration column in the FDC directory 400 can contain information about how each fulfillment and delivery client is configured. The configuration information can include what applications are installed/available, what file types are supported, and what access a file can be granted, etc. For example, the configuration information can indicate that a particular application (e.g., Microsoft PowerPoint, Microsoft Excel, Adobe Flash Player, RealPlayer, etc.) is installed or available on a fulfillment and delivery client. The configuration information can also indicate what file types are supported, e.g., whether a Microsoft Excel spreadsheet can be opened or edited on the fulfillment and delivery client, whether an Adobe Flash file can be run on the fulfillment and delivery client, whether a Real media file can be played on the fulfillment and delivery client, etc. The configuration information can also include any restriction information of the fulfillment and delivery client. For example, the configuration information can indicate a Microsoft Excel spreadsheet can be opened but cannot execute any macros or access certain portions of the local file system. The configuration information can further include other restriction requirements. For example, the configuration information can indicate that a movie rated above PG-13 cannot be played on the fulfillment and delivery client. Other type of client configuration information can also be included in the fulfillment and delivery directory.

The policy column in the FDC directory 400 can contain information about the policy information of each fulfillment and delivery client. In some embodiments, the policy of a fulfillment and delivery client can be universally configured and centrally controlled by a system administrator of a remote request fulfillment and delivery system. In some other embodiments, the policy of each fulfillment and delivery client can be individually configured and controlled. In some other embodiments, the policy of a fulfillment and delivery client can be based on a default policy and customizable by the fulfillment and delivery client. The policy information can include the time requirement or preference. For example, a policy can define that a fulfillment and delivery client can only accept remote requests or download files during a particular time period (e.g., daytime only, weekend only, off-peak hours preferred, etc.). The policy information can also include the size requirement or preference. For example, a policy can require that download files must be smaller than 1 GB. The policy information can further define the duration requirement or preference. For example, a policy can require that a file must take less than 1 minute to download. One way to estimate the download time is to calculate based on the file size and the projected network bandwidth. The policy information can also include security requirement. For example, a policy can prohibit a fulfillment and delivery client from accepting remote requests or downloading files from a certain source (e.g., an adult-oriented website); a policy can allow a fulfillment and delivery client to accept remote requests or download files only from sources inside a certain Intranet (e.g., an internal corporate network) or sub-network; a policy can allow a fulfillment and delivery client to accept remote requests or download files only from a certain group of fulfillment and delivery clients. Other type of client policy information can also be included in the fulfillment and delivery directory.

The group affiliation column in the FDC directory 400 can contain information about whether/how a fulfillment and delivery client is in certain groups. A remote request fulfillment and delivery system can be configured to contain groups. The groups can be configured based on various information (e.g., physical or logical location, capabilities, configuration, policy, etc.) The fulfillment and delivery clients in a remote request fulfillment and delivery system can optionally be categorized into one or more groups. The fulfillment and delivery clients in a group can share the same capabilities, configuration, or policy. In some embodiments, the group affiliation of a fulfillment and delivery client can be configured centrally by a system administrator of the remote request fulfillment and delivery system. In some other embodiments, the group affiliation of a fulfillment and delivery client can be customizable and set by individual fulfillment and delivery clients. Other type of client group affiliation information can also be included in the fulfillment and delivery directory.

A fulfillment and delivery client directory can have some or all the information discussed above. That is, just because the FDC directory 400 includes a column for certain types of information does not necessarily mean that each fulfillment and delivery client has the corresponding information associated with it. The FDC directory 400 is exemplary only and not limiting. For example, additional types of information can also be included for each fulfillment and delivery client in the FDC directory 400.

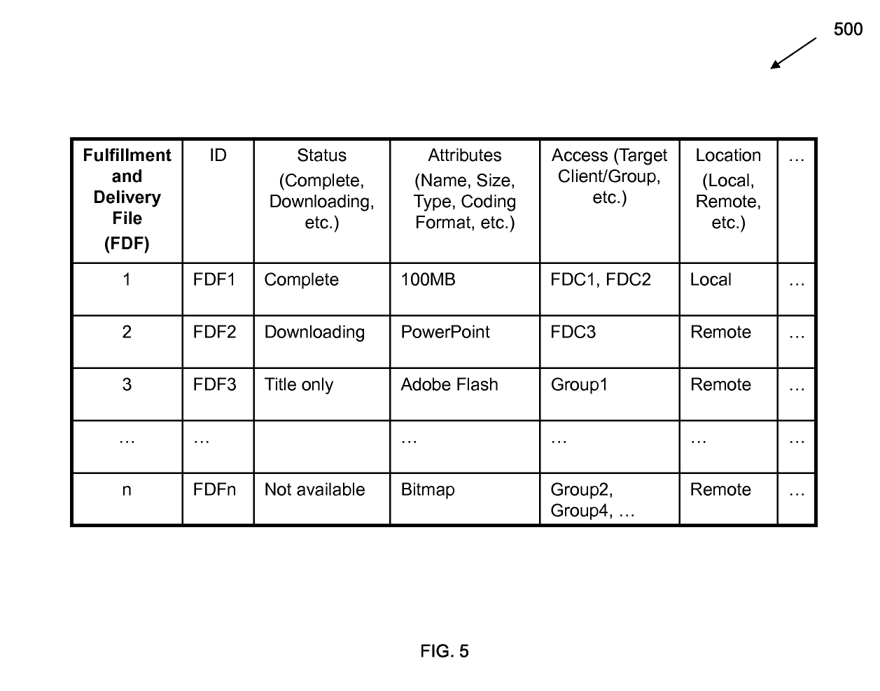

FIG. 5 illustrates an exemplary fulfillment and delivery file (FDF) directory 500 in a remote request fulfillment and delivery system 200. The FDF directory 500 can be used for maintaining information about the files to be shared and distributed within the remote request fulfillment and delivery system 200. The FDF directory 500 can contain the relevant information about the fulfillment and delivery files (e.g., file 1-n) in the fulfillment and delivery system 200. The term file herein is not limited to a traditional data file (e.g., a .JPG image) and can be in the form of various resources, such as an URL, a directory, etc. The FDF directory 500 can be updated automatically when a fulfillment and delivery file is added/removed/modified. The FDF directory 500 can also be modified manually by a system administrator of the remote request fulfillment and delivery system. For each fulfillment and delivery file (e.g., file1-n), the FDF directory 500 can include information, such as file ID, status, attributes, access, and location, etc.

The file ID (e.g., FDF1-n) of a fulfillment and delivery file can be used to uniquely identify a fulfillment and delivery file. The file ID can be assigned by the fulfillment and delivery client or its user. The file ID can also be randomly generated globally unique identifier (GUID) that uniquely identifies a file in the remote request fulfillment and delivery system 200. In some embodiments, the file ID can be derived from existing information to identify a fulfillment and delivery file. For example, the file ID can be determined based on its location and name. In another example, the file ID can be derived from a hash value of its content. Other forms of file ID can also be used in the fulfillment and delivery directory.

The status column in the FDF directory 500 can contain information about the current status of a fulfillment and delivery file. The status can indicate whether a fulfillment and delivery file is readily available or not. For example, the status can indicate that a file has been completely downloaded from the remote data source 250 and thus is readily available. The status can also indicate that a file is currently being downloaded from the remote data source 250. The status can also indicate that a portion of the file (e.g., a title or abstract of an online article) instead of the entire file (e.g., the online article itself) is readily available. The status can also indicate that a file is not available and can also optionally indicate a cause. Other types of file status information can also be included in the fulfillment and delivery directory.

The attributes column in the FDF directory 500 can contain information about the detailed description of a fulfillment and delivery file. The attributes information can include the file name, the file size, the file type, and the coding format, etc. The file name information can contain the file name set at file creation or modified thereafter. The file size information can indicate the size of the file, e.g., 100 MB. The file type information can indicate what type of file it is, e.g., a Microsoft PowerPoint presentation, a bitmap image, etc. The coding format information can indicate the format used to encode the file or the file format of the file. For example, an Adobe Flash file may require an Adobe Flash Player to run; a MPEG-4 movie file may need a proper MPEG-4 decoder to play. Other types of file attributes information can also be included in the fulfillment and delivery directory.

The access column in the FDF directory 500 can contain information about how a fulfillment and delivery file can be accessed by various fulfillment and delivery clients in the remote request fulfillment and delivery system. For example, as illustrated in FIG. 5, file FDF1 is targeted at and can be downloaded only by clients FDC1 and FDC2; file FDF2 is targeted at and can be downloaded only by client FDC3; file FDF3 is targeted at and can be downloaded only by the fulfillment and delivery clients within Group1; file FDFn is targeted at and can be downloaded only by the fulfillment and delivery clients within Group2 and Group4. The access information of a file can be set by a fulfillment and delivery client when it sends the remote request. The access information of a file can also be set or modified by the fulfillment and delivery server. Other type of access information can also be included in the fulfillment and delivery directory.

The location column in the FDF directory 500 can contain information about the logical and/or physical location information of a fulfillment and delivery file. For example, a location can indicate that a fulfillment and delivery file is located on the local system (e.g., the fulfillment and delivery server itself) or on a remote resource (e.g., the remote data source 250). Other type of location information can also be included in the fulfillment and delivery directory.

The FDF directory 500 is exemplary only and not limiting. For example, a fulfillment and delivery file directory can have some or all the information discussed above. Additional types of information can also be included in a fulfillment and delivery file directory.

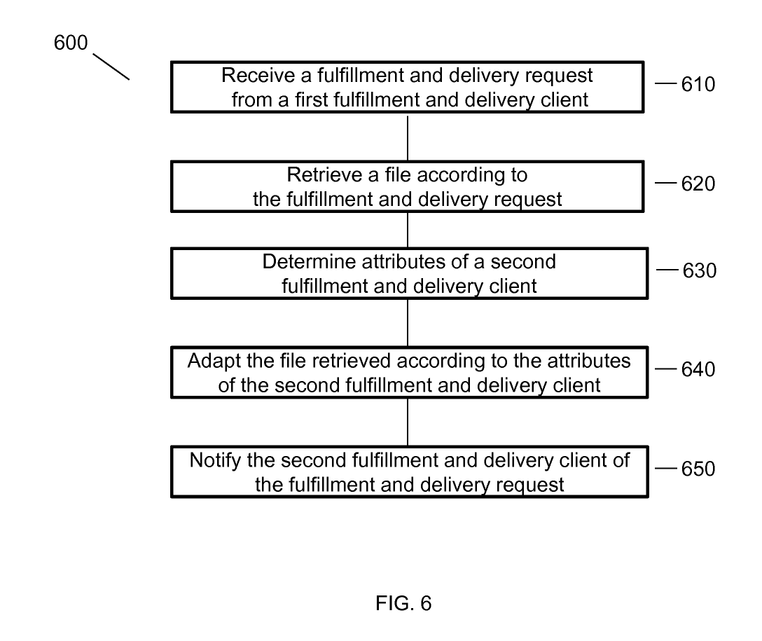

FIG. 6 illustrates an exemplary operation 600 of the remote request fulfillment and delivery system 200. The operation 600 can be modified by, for example, having stages rearranged, changed, added and/or removed.

At stage 610, a fulfillment and delivery server 220 can receive a fulfillment and delivery request from a first fulfillment and delivery client 210A. The fulfillment and delivery request can contain basic information about the source client, target client, and the requested file. In one example, the first fulfillment and delivery client 210A requests to send a file to a second fulfillment and delivery client 210B; the requested file can be located on a remote data source 250. The first fulfillment and delivery client 210A may or may not have knowledge of the status, capabilities, or configuration of the second fulfillment and delivery client 210B. The second fulfillment and delivery client 210B may be a remote device with limited resources (e.g., a mobile device operated on battery and connected to a slow and unreliable cellular network). The first and second fulfillment and delivery clients 210A and 210B may be owned or controlled by a same user or different users. If the first and second fulfillment and delivery clients 210A and 210B have already registered with and logged onto the fulfillment and delivery server 220, they may already be listed in the FDC directory 400 on the fulfillment and delivery server 200. Alternatively, the first fulfillment and delivery client 210A can be registered with or logged on to the fulfillment and delivery server 200 on-demand and added to the FDC directory 400 when the remote request arrives at the fulfillment and delivery server 200. When the fulfillment and delivery server 220 receives a fulfillment and delivery request, the requested file can also be added to the FDF directory 500. If the requested file is already listed in the fulfillment and delivery file directory 500, the existing entry can be updated accordingly.

At stage 620, the fulfillment and delivery server 220 can process the received remote request. The requested file may be available locally on the fulfillment and delivery server 220 (e.g., from a cache of a previous download). If the requested file is not already available locally, the fulfillment and delivery server 220 can retrieve the requested file from its source. The requested file may be available on the originating fulfillment and delivery client (e.g., the first fulfillment and delivery client 210A) or on another remote source (e.g., the remote data source 250). The fulfillment and delivery server 200 can start downloading the requested file as soon as it receives the remote request. Alternatively, the file downloading can be scheduled for a later time. In one example, the file downloading can be scheduled to occur during an off-peak hour to avoid network congestion and minimize impact on the network performance. In another example, the remote request itself can contain information about a preferred or required downloading schedule. In some embodiments, the downloading can be scheduled on a recurring basis. For example, the fulfillment and delivery server 220 can be configured to download a specified file from a particular remote source on a daily basis in order to obtain recent updates. In some other embodiments, the fulfillment and delivery server 220 can download the requested file in its entirety at once; or can divide the requested file into smaller segments and download the smaller segments separately in sequential or in parallel.

In some situations, the fulfillment and delivery server 220 may retrieve only a portion of the requested file. For example, when the first fulfillment and delivery client 210A wants to send the second fulfillment and delivery client 210B an article stored on a remote data source 250, the remote request may only contain an URL to the article. In this situation, instead of downloading the entire article referred by the URL, the fulfillment and delivery server can be configured to download only the title or abstract of the article from the remote data source 250 using the URL. In another example, if a fulfillment and delivery request refers to a video clip, instead of downloading the entire video clip, the fulfillment and delivery server 220 may be configured to download only the textual description of the video clip or a portion (e.g., the first five seconds) of the video clip. In some embodiments, the fulfillment and delivery server 220 can determine the mime type of an URL (e.g., using the HTTP HEAD verb), download the requested file, then extract data or meta-data from the downloaded file. For example, if an URL points to an HTML page, the fulfillment and delivery server 220 can download the whole HTML page then extract the page title from the downloaded HTML page. The fulfillment and delivery server 220 can also be configured to store only the extracted page title and discard the rest of the HTML page. In another example, if the HTML page contains associated contents (e.g., embedded images), the fulfillment and delivery server 220 can download the HTML page then generate a reduced-size representation of the associated contents (e.g., thumbnails of the images). The fulfillment and delivery server 220 can also be configured to store only the thumbnails and discard the full-size images.

At stage 630, the fulfillment and delivery server 220 can determine the attributes of the target fulfillment and delivery client (e.g., the second fulfillment and delivery client 210B). For example, the fulfillment and delivery server 220 can determine the status, capabilities, configuration, policy, and group affiliation. In some embodiments, these attributes information can already exist in the fulfillment and delivery client directory 400 and can be retrieved based on the client ID. In some other embodiments, these attributes information can be contained in the received remote request. The fulfillment and delivery agent 240 on the target fulfillment and delivery client can help gather information (e.g., capabilities, configuration, etc.) about the host client.

At stage 640, the fulfillment and delivery server 220 adapts the retrieved file according to the attributes of the target fulfillment and delivery client (e.g., the second fulfillment and delivery client 210B). The file adaption (e.g., conversion or transcoding, etc.) can transform the retrieved file into a form which is suitable for the target fulfillment and delivery client (e.g., the fulfillment and delivery client 210B). In some situations, the more suitable form is required; in some other situations, the more suitable form is merely preferred.

In one example, if the requested file is a 50 MB bitmap file and the target fulfillment and delivery client only accepts files up to 25 MB, the fulfillment and delivery server 200 can compress the requested file or downgrade its resolution so that its size falls within the target fulfillment and delivery client's maximum limit. Alternatively, the fulfillment and delivery server 200 can convert the image file into a different coding format (e.g., JPEG) to reduce its size. In another example, if the size of the requested file is within the maximum limit but the download is projected to take too long beyond a certain threshold (e.g., 1 minute) due to a slow network connection, the fulfillment and delivery server 200 can also adapt the requested file accordingly so that the projected download time stays within the limit. In another example, if the requested file is a Microsoft PowerPoint file but the target client does not have Microsoft PowerPoint application or viewer installed, the fulfillment and delivery server 200 can convert the PowerPoint file into a format (e.g., Adobe PDF) that is supported on the target client 210B. In another example, if the requested file is an Adobe Flash file and the target client does not support Adobe Flash, the fulfillment and delivery server 200 can convert the Adobe Flash file into a different format (e.g., .mpg or .avi) so that the file is playable on the target client 210B. In yet another example, when the requested file is a PowerPoint presentation, the fulfillment and delivery server 200 can convert the PowerPoint file into an HTML page (e.g., with embedded JavaScript scripts and any associated images) so that it can be viewed using web browsers.

At stage 640, the fulfillment and delivery server 220 can notify the target fulfillment and delivery client (e.g., the second fulfillment and delivery client 210B) of the fulfillment and delivery request. The fulfillment and delivery server 220 can send a notification to the second fulfillment and delivery client 210B. In one example, the second fulfillment and delivery client 210B can be notified that a file is readily available and can be downloaded (e.g., from the fulfillment and delivery server 220). The notification can contain the ID of the file in the fulfillment and delivery system. The notified fulfillment and delivery client can then use the ID to retrieve the corresponding file (e.g., from the fulfillment and delivery server 220). In some embodiments, the notification can be of a small size so that it can be delivered by cloud push mechanisms, such as GCM (Google) or APN (Apple). In another example, the second fulfillment and delivery client 210B can be notified that an article is ready to be retrieved (e.g., from the fulfillment and delivery server 220). In this example, the notification can contain the URL to the article. Optionally and alternatively, the notification can contain the title or abstract of the article so that the second fulfillment and delivery client can have more information to help determine whether to download the full article.

Once the second fulfillment and delivery client 210B is notified, it can choose whether or not to download the requested file (e.g., from the fulfillment and delivery server 220). In some embodiments, the requested file is available on the fulfillment and delivery server 200 in its entirety and can be readily downloaded. In some other embodiments, only a portion of the requested file is available on the fulfillment and delivery server 200. For example, only a title or abstract of an article or only a first few seconds of a movie is available on the fulfillment and delivery server 200. The second fulfillment and delivery client 210B can download the article's title/abstract or the first few seconds of the movie to preview and make informed decision whether the entire file is desired. If the second fulfillment and delivery client 210B wants to access the entire file, it can inform the fulfillment and delivery server 200 which can in turn download the entire file then inform the second fulfillment and delivery client 210B when the entire file is available for download. Alternatively, the second fulfillment and delivery client 210B can download the entire file from the remote data source 250 directly.

Optionally, before notifying the target client 210B, the fulfillment and delivery server 220 can check and verify the policy and group affiliation of the target client with the access of the requested file. For example, if the requested file is set to only target clients within Group1, the fulfillment and delivery server 220 can check the group affiliation of the second fulfillment and delivery client and make sure it belongs to Group1.

The adaptation step 640 can be configured to occur before the notification step 650. Alternatively, the notification can be sent before the adaptation is started or completed. Or, the adaption process can start or finish on-demand once the second fulfillment and delivery client 210B responds positively to the notification.

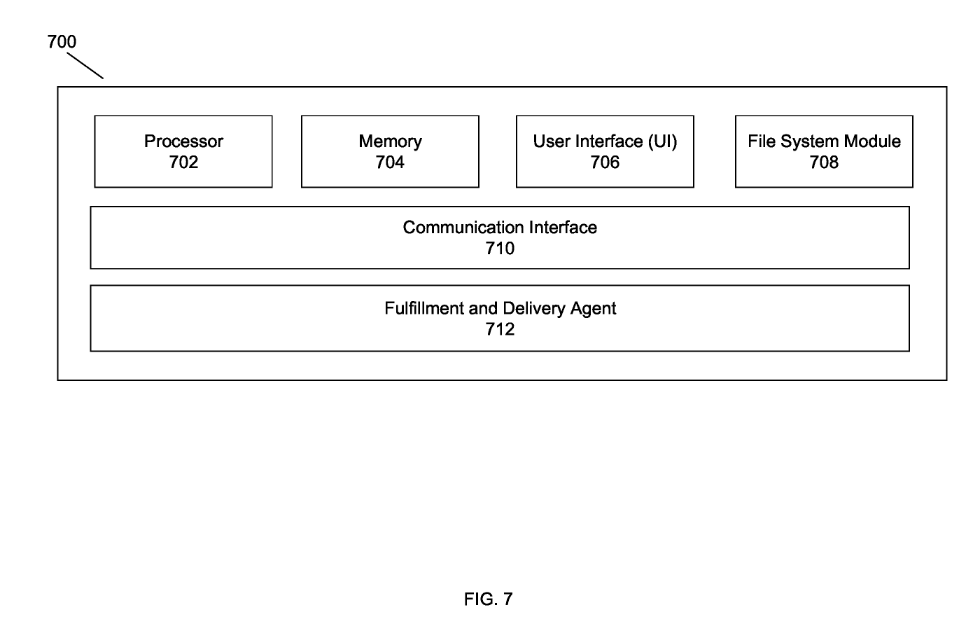

FIG. 7 illustrates a block diagram of a computing system that can be used to implement one or more aspects of the functionality described herein. The computing system 700 can serve as, for example, a client 106, a server 104, or both in the networked communication arrangement 100. The computing system 700 can also serve as, for example, a fulfillment and delivery client 210A or 210B, a fulfillment and delivery server 220, a remote data source 250, or any combinations of them in the remote request fulfillment and delivery system 200. The computing system 700 can include at least one processor 702 and at least one memory 704. The processor 702 can be hardware that is configured to execute computer readable instructions such as software. The processor 702 can be a general processor or be an application specific hardware (e.g., an application specific integrated circuit (ASIC), programmable logic array (PLA), field programmable gate array (FPGA), or any other integrated circuit). The processor 702 can execute computer instructions or computer code to perform desired tasks. The memory 704 can be a transitory or non-transitory computer readable medium, such as flash memory, a magnetic disk drive, an optical drive, a programmable read-only memory (PROM), a read-only memory (ROM), or any other memory or combination of memories.

The computing system 700 can also optionally include a user interface (UI) 706, a file system module 708, and a communication interface 710. The UI 706 can provide an interface for users to interact with the computing system 700 in order to access the remote request fulfillment and delivery system 200. The file system module 708 can be configured to maintain a list of all data files, including both local data files and remote data files, in every folder in a file system. The file system module 708 can be further configured to coordinate with the memory 704 to store and cache files/data. The communication interface 710 can allow the computing system 700 to communicate with external resources (e.g., a network or a remote client/server). The computing system 700 can also include a fulfillment and delivery agent 712. The description of the fulfillment and delivery agent 712 and its functionalities can be found in the discussion of FIGS. 2-6. The computer system 700 can include additional modules, fewer modules, or any other suitable combination of modules that perform any suitable operation or combination of operations.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions.

What is claimed is:

1. A computerized method of sharing and distributing data among computing devices, the method comprising:
receiving at a server a request from a first computing device, wherein the request targets a second computing device and contains information about a data object;
retrieving, using the server, at least a portion of the data object from a source of the data object;
determining, using the server, attributes of the second computing device;
adapting at least a portion of the data object according to the attributes of the second computing device; and
notifying the second computing device of an availability of the data object.

2. The computerized method of claim 1, wherein the source of the data object is related to a third computing device.

3. The computerized method of claim 1, wherein the determining step includes determining configuration of the second computing device.

4. The computerized method of claim 1, wherein the adapting step includes converting the at least a portion of the data object into a different format suitable for the second computing device.

5. The computerized method of claim 1, wherein the retrieving step includes retrieving the at least a portion of the data object based on a schedule.

6. The computerized method of claim 5, wherein the retrieving step includes retrieving the at least a portion of the data object on a recurring basis.

7. The computerized method of claim 1, further comprising retrieving more of the data object based on a response from the second computing device.

8. A non-transitory computer readable medium having executable instructions operable to, when executed by a processor, cause the processor to:
receive at a server a request from a first computing device, wherein the request targets at a second computing device and contains information about a data object;
retrieve, using the server, at least a portion of the data object from a source of the data object;
determine, using the server, attributes of the second computing device;
adapt at least a portion of the data object according to the attributes of the second computing device; and
notify the second computing device of an availability of the data object.

9. The non-transitory computer readable medium of claim 8, wherein the source of the data object is related to a third computing device.

10. The non-transitory computer readable medium of claim 8, wherein the executable instructions are further operable to cause the processor to determine configuration of the second computing device.

11. The non-transitory computer readable medium of claim 8, wherein the executable instructions are further operable to cause the processor to convert the at least a portion of the data object into a different format suitable for the second computing device.

12. The non-transitory computer readable medium of claim 8, wherein the executable instructions are further operable to cause the processor to retrieve the at least a portion of the data object based on a schedule.

13. The non-transitory computer readable medium of claim 12, wherein the executable instructions are further operable to cause the processor to retrieve the at least a portion of the data object on a recurring basis.

14. The non-transitory computer readable medium of claim 8, wherein the executable instructions are further operable to cause the processor to retrieve more of the data object based on a response from the second computing device.

15. A control server for managing sharing and distributing data among computing devices, the control server comprising:
a non-transitory memory storing computer readable instructions, a client directory, and a file directory; and
a processor coupled to the non-transitory memory and configured to execute the computer readable instructions;
wherein the computer readable instructions are configured to cause the control server to:
receive at the control server a request from a first client, wherein the request targets a second client and contains information about a data object;
retrieve, using the control server, at least a portion of the data object from a source of the data object;
determine, using the control server, attributes of the second client;
adapt at least a portion of the data object according to the attributes of the second client; and
notify the second client of an availability of the data object.

16. The control server of claim 15, wherein the source of the data object is related to a third computing device.

17. The control server of claim 15, wherein the computer readable instructions are further configured to cause the control server to determine configuration of the second client.

18. The control server of claim 15, wherein the computer readable instructions are further configured to cause the control server to convert the at least a portion of the data object into a different format suitable for the second client.

19. The control server of claim 15, wherein the computer readable instructions are further configured to cause the control server to retrieve the at least a portion of the data object based on a schedule.

20. The control server of claim 19, wherein the computer readable instructions are further configured to cause the control server to retrieve the at least a portion of the data object on a recurring basis.

21. The control server of claim 15, wherein the computer readable instructions are further configured to cause the control server to retrieve more of the data object based on a response from the second client.
